(19) United States
(12) Patent Application Publication
(10) Pub. No.: US 2009/0046760 A1
(43) Pub. Date: Feb. 19, 2009

(54) Thermochromic Temperature-Monitoring Clothing

(76) Inventor: John Peter Matheson, Malden, MA (US)

Correspondence Address: John P. Matheson, 26 Bartlett Street, Malden, MA, 02148, US

(21) Appl. No.: 12/191,888

(22) Filed: Aug. 14, 2008

Related U.S. Application Data
(60) Provisional application No. 60/964,539, filed on Aug. 14, 2007.

(51) Int. Cl. G01K 11/12; G01K 13/00

(52) U.S. Cl. 374/141; 374/162; 374/E13.002; 374/E11.018

(57) ABSTRACT

Thermochromic Temperature-Monitoring Clothing, is the first apparel invention to provide early detection and prevention of cold exposure to skin surface via thermochromism. The invention is comprised of various outerwear for adults, children, babies and/or infants which visibly displays dermal temperature by employing thermochromic color changing characteristics via thermochromic dye incorporated into the fabric of the apparel, and/or fabric affixed to the apparel at the extremities, and/or thermochromic device affixed to the apparel. Prior art related to thermochromic color change in apparel has been exclusively related to aesthetic considerations, and not for any perceived health benefits or for monitoring and communicating skin temperatures. Therefore, Thermochromic Temperature-Monitoring Clothing serves a useful purpose and satisfies a long neglected need in the area of apparel and health maintenance.

### PROVISIONAL APPLICATION NUMBER

60/964,539

### PROVISIONAL APPLICATION FILE DATE

Aug. 14, 2007

### STATEMENT REGARDING FEDERALLY SPONSORED RESEARCH

Not applicable.

### BACKGROUND OF THE INVENTION

The field of the invention relates to outerwear for adults, children, babies and/or infants. More specifically, outerwear apparel which visibly displays dermal temperature by employing thermochromic color changing characteristics via thermochromic dye incorporated into the fabric of the apparel, and/or fabric affixed to the apparel, and/or thermochromic device affixed to the apparel. Prior art related to thermochromic color change in apparel solely concerned aesthetic considerations, and not for any perceived health benefits or for monitoring and detecting skin surface temperatures.

### BRIEF SUMMARY OF THE INVENTION

Thermochromic dyes and their use in fabric and devices is known. Thermochromic dyes allow a reversible color change as a function of temperature change. For instance, a thermochromic dye incorporated into a material appears transparent until the material reaches a certain temperature, at which time, due to an electron exchange, the color pigment of the thermochromic dye is released from encapsulations and the material takes on the color of the pigment. Thermochromic materials can be formulated to “change” color when temperatures rise or fall above or below one or more pre-defined ranges.

Apparel which employ thermochromic dye is also known, but only with respect to its aesthetic usefulness. Contrarily, the subject invention, Thermochromic Temperature-Monitoring Clothing, is the first to monitor dermal temperatures for health maintenance and safety. The invention is apparel which visibly displays dermal temperature by employing thermochromic color changing characteristics either via thermochromic dye embedded within the fabric of the apparel, or by the addition of a second fabric embedded with thermochromic dye and affixed to the apparel, or by the addition of a thermochromic device which identifies dermal temperature using thermochromic color change.

The subject invention and its use of thermochromism is unique and distinct from the prior art. As an example of related art, please refer to “thermochromic waterproof apparel,” U.S. Pat. No. 6,990,688; and “surface temperature measuring device with reversible thermochromic film,” U.S. Pat. No. 4,445,787. The former invention claims thermochromic color change in waterproof clothing for its aesthetically pleasing appearance while the latter invention measures the surface of a solid object by repeatedly bending a metal blade over the surface, conducting heat and changing color through thermochromism. These inventions are distinct from the subject invention because neither monitors dermal or skin surface temperatures. In addition, the former invention uses a metal blade as its medium, whereas the subject invention employs thermochromic dye incorporated into apparel fabric or apparel fabric affixed with a thermochromic device that measures temperature. The cited inventions do not serve the same need or purpose as the subject invention. Furthermore, the subject invention is not made obvious by the cited inventions nor is it anticipated by any prior art.

The thermochromic color change in Thermochromic Temperature-Monitoring Clothing visibly communicates skin temperatures in order to monitor departures from the desirable range. Temperature visibility assists the detection and prevention of dangerous health conditions such as frostbite and hypothermia, among others, especially where the individual wearing the apparel is unable to communicate their condition to their parent or caregiver, such as babies and infants; or similarly the infirmed, disabled, elderly or those with circulatory disorders, such as peripheral neuropathy or venous insufficiency.

Babies, infants, the infirmed, disabled, and/or those with circulatory disorders, such as peripheral neuropathy or venous insufficiency may be experiencing a medically urgent condition such as hypothermia and/or frostbite and be unable to communicate the same to their parent or caregiver. This may cause an uninformed parent or caregiver to exacerbate the damage to the tissue by rubbing skin in an effort to test the temperature and warm it up. Parents or caregivers can also damage tissue by using a heating pad, heat lamp, stove, fireplace, or radiator to re-warm the affected area as it may warm skin unevenly or burn the skin, particularly if it's numb and one cannot tell how hot the skin is becoming on the surface. It is therefore desirable to have a fabric or device capable of thermochromic color change to easily display temperature deviations for a parent or caregiver to take the appropriate corrective action.

### DESCRIPTION OF THE INVENTION

Thermochromic Temperature-Monitoring Clothing is an effective way to monitor and identify dangerously skin surface temperatures based on the color of the apparel fabric or fabric affixed to the apparel or a thermochromic device incorporated therein. This is especially effective in monitoring babies and infants; or similarly monitoring the infirmed, disabled, elderly or those with circulatory disorders, such as peripheral neuropathy or venous insufficiency. Since extremities are the most vulnerable areas of the body, the clothing can take the form of shirts, wrist cuffs, sleeves, necklines, trousers, waistlines, ankle-cuffs, hats, gloves or socks, etc, or be affixed with the same.

A thermochromic dye or dyes incorporated into fabric appears transparent until the material reaches a predetermined, desired temperature, at which time, due to an electron exchange, the color pigment of the thermochromic dye is released from encapsulations and the material takes on the color of the pigment. Thermochromic materials can be formulated to “change” color when temperatures rise or fall above or below a pre-defined range. More than one thermochromic dye can be added in order that said apparel evidences a thermochromic color scheme that includes more than one thermochromic temperature driven color change. The active chemical, thermochromic dye, has been previously employed in apparel for its aesthetic benefits, and is safe for human contact. Thermochromic dyes have never been employed in apparel for their qualities as a thermometer, or as an early detection and prevention of the dangerous effects of exposure to cold by monitoring skin surface temperature through color changing.

Apparel can be comprised of thermochromic dye either infused directly into the fiber of the apparel, and/or by the addition of a second fabric affixed, preferably but not necessarily at the extremities of the outer apparel, and/or by the addition of a thermochromic device to the apparel. (Examples of thermochromic devices are aquarium thermostat strips, forehead thermometer strips, etc.) Each method would enable a thermochromic reaction which can visibly communicate dermal temperatures of the desirable predetermined range.

The clothing communicates skin temperature by changing one or more colors, each of which are activated upon contact with skin within certain temperature ranges. Parents and caregivers can easily detect a dangerous condition by easily viewing the thermochromic device or through the thermochromic encapsulated fabric of the apparel. For example, if treated fabric is joined to the apparel by attaching it to the inner shirt cuff, a parent may turn the cuff to reveal the color of the fabric and hence, the temperature of the skin surface of the child.

Preventable Dangers of Cold Temperature Exposure:

Healthy skin provides a barrier between the inside of the body and the outside environment. It's easy to get cold quickly if one is outside in wet, windy, or cold weather. Cold temperature exposure can also happen if you spend time indoors in an area that is not well-heated during cold weather.

Children are at greater risk for frostbite and hypothermia. If one has frostbite, he may not realize at first that anything is wrong because the affected area will be numb. In severe cases permanent damage is possible depending on how long and how deeply the tissue is frozen. In severe cases, blood flow to the area may stop and blood vessels, muscles, nerves, tendons and bones may be permanently affected. If the frozen tissue dies, the area may need to be amputated. In cases of severe hypothermia coma and death may occur.

Frostnip. Frostnip is the beginning stage of Frostbite, Hypothermia, and other cold-related injuries. Extremities, such as fingers and toes become white and numb and can become dangerous if not addressed promptly. “Frostnip” usually affects skin on the extremities.

Frostbite. Frostbite refers to the freezing of body tissue that results in loss of feeling and color in the tissue. Frostbite is freezing of the skin and the tissues under the skin caused by prolonged exposure to cold temperatures, particularly when accompanied by a low wind-chill factor or by briefer exposure to very cold temperatures. There are three degrees of frostbite: frostnip, superficial frostbite, and deep frostbite.

Hypothermia. Hypothermia occurs when the body loses heat faster than the body can make it. Hypothermia can occur from exposure to cold air, water, wind, or rain. Body temperatures can drop to a low level at temperatures of 50° F. (10° C.) or higher in wet and windy weather, or in 60° F. (16° C.) to 70° F. (21° C.) water. Hypothermia is an emergency condition as it can quickly lead to unconsciousness, coma and death if the heat loss is not stopped.

Other cold injuries can also occur where the skin does not actually freeze. A dangerous reaction to cold such as chilblains can occur in non-freezing temperatures. It is seen most often in young people who suffer from Raynaud's Syndrome and people who are exposed to damp, cold weather, may cause pale and blistered skin like frostbite after the skin has warmed. These injuries occur from spending too much time in cold temperatures that are above freezing. Moreover, those with circulatory disorders such as peripheral neuropathy or venous insufficiency may be experiencing a medically urgent condition and be unable to communicate the same to their parent or caregiver.

Thermochromism:

In chemistry, chromism is a process that induces a reversible change in the colors of compounds. In most cases, chromism is based on a change in the electron states of molecules, especially the π- or d-electron state, so this phenomenon is induced by various external stimuli which can alter the electron density of substances. It is known that there are many natural compounds that have chromism, and many artificial compounds with specific chromism have been synthesized to date. Chromism is classified by what kinds of stimuli are used. The major kinds of chromism are as follows:

“Thermochromism” is chromism that is induced by heat, that is, a change of temperature. This is the most common chromism of all. “Photochromism” is induced by light irradiation. This phenomenon is based on the isomerization between two different molecular structures. “Electrochromism” is induced by the gain and loss of electrons. This phenomenon occurs in compounds with redox active sites, such as metal ions or organic radicals. “Solvatochromism” depends on the polarity of the solvent. Most solvatochromic compounds are metal complexes. Chromic phenomena are those phenomena in which color is produced when light interacts with materials in a variety of ways. “Ionochromism” is a color change caused by ions. “Halochromism” is a color change caused by a change in pH. “Tribochromism” is a color change caused by mechanical friction.

Thermochromic dye(s) can be incorporated into fabric enclosed in microcapsules tiny (a few micrometers in diameter) drops of liquid sealed in a transparent shell, bound to the fibers of the fabric. The liquid is a leuco form of a dye (for instance, crystal violet lactone), a weak acid (1,2,3-benzotriazole), and a quaternary ammonium salt of a fatty acid (myristylammonium oleate) dissolved in a solvent (lauryl alcohol). At low temperatures, the weak acid forms a colored complex with the leuco dye, interrupting the lactone ring. At high temperatures, above 24-27° C., the solvent melts and the salt dissociates, reversibly reacts with the weak acid and increases the pH. The pH change leads to closing of the lactone ring of the dye, which then regains its colorless (leuco) form. Therefore, at the low temperature the color of the apparel may be the combination of the color of the microcapsules with the color of the dyed fabric, while at higher temperatures the capsules may become colorless and the color of the fabric prevails.

Thermochromism is the ability of a substance to change color due to a change in temperature, such as a mood ring, but it has many other uses. Thermochromism is one of several types of chromism. Thermochromic inks or dyes are temperature sensitive compounds that temporarily change color with exposure to heat. Leuco dyes applications include: flat thermometers, battery testers, and the indicator on bottles of maple syrup that change color when the syrup is warm, or on the exterior of aquariums, or to obtain a body temperature via the forehead.

Thermochromic dyes are based on mixtures of leuco dyes with suitable other chemicals, displaying a color change (usually between the colorless leuco form and the colored form) in dependence on temperature. The dyes are rarely applied on materials directly; they are usually in the form of microcapsules with the mixture sealed inside. For example, where microcapsules with crystal violet lactone, weak acid, and a dissociable salt dissolved in dodecanol are applied to the fabric; when the solvent is solid, the dye exists in its lactone leuco form, while when the solvent melts, the salt dissociates, the pH inside the microcapsule lowers, the dye becomes protonated, its lactone ring opens, and its absorption spectrum shifts drastically, therefore it becomes deeply violet. In this case the apparent thermochromism is in fact halochromism. The dyes most commonly used are spirolactones, fluorans, spiropyrans, and fulgides. The weak acids include bisphenol A, parabens, 1,2,3-triazole derivates, and 4-hydroxycoumarin and act as proton donors, changing the dye molecule between its leuco form and its protonated colored form; stronger acids would make the change irreversible.

Color, Heat and Chromism:

Color is the perception of the frequency (or wavelength) of light, and can be compared to how pitch (or a musical note) is the perception of the frequency or wavelength of sound. It is a perception which in humans derives from the ability of the fine structures of the eye to distinguish (usually three) differently filtered analyses of a view. The perception of color is influenced by biology (some people are born seeing colors differently or not at all; see color blindness), long-term history of the observer, and also by short-term effects such as the colors nearby (The basis of many optical illusions). The science of color is sometimes called chromatics. It includes the perception of color by the human eye, the origin of color in materials, color theory in art, and the physics of color in the electromagnetic spectrum.

Colors of the visible light spectrum:
color wavelength interval frequency interval

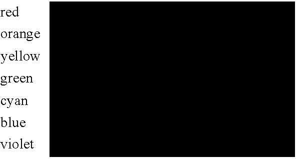

Heat (also improperly called heat change) is the transfer of thermal energy due to a temperature gradient. The SI unit for heat is the joule. Heat is a process quantity, and is to thermal energy as work is to mechanical energy. Heat flows between regions that are not in thermal equilibrium with each other; it spontaneously flows from areas of high temperature to areas of low temperature. All objects (matter) have a certain amount of internal energy (a state quantity) that is related to the random motion of their atoms or molecules. When two bodies of different temperature come into thermal contact, they will exchange internal energy until the temperature is equalized (that is, until they reach thermal equilibrium).

The amount of energy transferred is the amount of heat exchanged. It is a common misconception to confuse heat with internal energy: heat is related to the change in internal energy and the work performed by the system. The term heat is used to describe the flow of energy, while the term internal energy is used to describe the energy itself. Understanding this difference is a necessary part of understanding the first law of thermodynamics. Infrared radiation is often linked to heat, since objects at room temperature or above will emit radiation mostly concentrated in the mid-infrared band.

I claim:

1. Apparel for adults and/or children, including but not limited to a shirt, and/or sleeves, and/or wrist cuffs, and/or a neckline, and/or a trousers, and/or ankle cuffs, and/or a waistline, and/or a hat, and/or gloves, and/or socks, comprised of fabric incorporating a thermochromic, color-changing additive(s) and/or dye(s) imbedded into the fabric of the apparel which evidences a thermochromic change in color and/or colors in response to a dermal condition indicating skin temperature including but not limited to departures from the normal and/or desired range and may include fabric containing more than one thermochromic dye where said apparel evidences a thermochromic color scheme that includes more than one thermochromic temperature driven color change.

2. Apparel in claim 1 wherein said apparel is comprised of the addition of, and/or in combination with, a second fabric, such as that identified in claim 1, affixed to the apparel, in whole or in part, which evidences a thermochromic change in color and/or colors in response to a dermal condition for the purpose of detecting a departure of skin temperature from the normal and/or desired range.

3. Apparel of claims 1 and 2, wherein said apparel is comprised of the addition of, and/or in combination with, and/or affixed with a device that evidences a thermochromic change in color and/or colors in response to a dermal condition for the purpose of detecting a departure of skin temperature from the normal and/or desired range. Thermochromic devices include, for example, strip thermometers or aquarium thermostat strips, etc., which change color to identify temperature change).
